(19) United States
(12) Patent Application Publication
(10) Pub. No.: US 2023/0115295 A1
(43) Pub. Date: Apr. 13, 2023

(54) Swift CO2 Capture and Disposal System

(71) Applicant: Jocelyn Bruno, Cibolo, TX (US)

(72) Inventor: Jocelyn Bruno, Cibolo, TX (US)

(21) Appl. No.: 17/723,375

(22) Filed: Apr. 18, 2022

Related U.S. Application Data
(63) Continuation-in-part of application No. 17/496,596, filed on Oct. 7, 2021.
Application No. 17/496,596 is a continuation-in-part of application No. 17/521,883, filed on Nov. 9, 2021.

(51) Int. Cl. B01D 53/62; B01D 53/22; B01D 71/60

(52) U.S. Cl. CPC B01D 53/62; B01D 53/229; B01D 53/228; B01D 71/60; B01D 2257/504; B01D 2258/06; B01D 2253/106

(57) ABSTRACT

An article of manufacture for providing a Swift CO2 capture and disposal system for removing CO₂ gas from the atmosphere according to the present invention is disclosed.

### CROSS-REFERENCES TO RELATED APPLICATIONS

This application is a continuation in part that claims the benefit of non-provisional application Ser. No. 17/521,883 entitled O₂ TREE FOR ADDRESSING CLIMATE CHANGE, filed Nov. 8, 2021, which is a Continuation-in-Part of U.S. Ser. No. 17/496,596, filed Oct. 7, 2021. These non-provisional applications are incorporated in its entirety by reference.

### TECHNICAL FIELD

This application relates in general to an article of manufacture for providing an environmental treatment device, and more specifically, to an article of manufacture for providing a Swift CO₂ capture and disposal system for removing CO₂ gas from the atmosphere.

### BACKGROUND

Greenhouse gases trap heat and make the planet warmer. According to the U.S. Environmental Protection Agency (EPA), human activities are responsible for nearly all the increase in greenhouse gases in our atmosphere over the last 150 years. Since 1990, gross U.S. greenhouse gas emissions have increased by 2 percent. The largest source of greenhouse gas emissions from human activities in the U.S. is from burning fossil fuels for electricity, heat, and transportation. Land areas can act as a sink (absorbing CO₂ from the atmosphere) or a source of greenhouse gas emissions. Since 1990 in the U.S., managed forests and other lands are a net sink; they have absorbed more CO₂ from the atmosphere than they emit. With this in mind, the present invention can be manufactured as artificial ‘trees’ to capture and dispose of CO₂.

Therefore, a need exists for an article of manufacture for providing a Swift CO₂ capture and disposal system for removing CO₂ gas from the atmosphere. The present invention attempts to address the limitations and deficiencies in prior solutions according to the principles and example embodiments disclosed herein.

### SUMMARY

In accordance with the present invention, the above and other problems are solved by providing an article of manufacture for a Swift CO₂ capture and disposal system for removing CO₂ gas from the atmosphere according to the principles and example embodiments disclosed herein.

In one embodiment, the present invention is an article of manufacture for providing a Swift CO₂ capture and disposal system for removing CO₂ gas from the atmosphere. The Swift CO2 capture and disposal system includes a capture chamber having a specialized filter that behaves like fly-trap for CO₂ to capture CO₂ from incoming ambient air being blown into the capture chamber input port and exiting via an exhaust port from the capture chamber back to the atmosphere. Upon the specialized filter reaching saturation, the CO₂ disposal phase begins, whereby (1) A hot water source with temperature above 185 degrees Fahrenheit is connected to the input port and (2) A drain line connected to the output port is routed to the CO₂ disposal unit. When exposed to temperatures of 185 degrees Fahrenheit or higher, the specialized filter loses the ability to hold the CO₂ that is now free flowing and being routed to the CO₂ disposal unit. The CO₂ disposal unit is a well containing materials that prevent dumped CO₂ from returning to the surface and back to the atmosphere.

In another aspect of the present invention, the filter element utilizes polyethyleneimine (PEI) laced with silica to bind the CO₂ to the filter element.

In another aspect of the present invention, the Swift CO₂ capture and disposal system is powered by rechargeable batteries that are being continually recharged by solar power. Instead of rechargeable batteries, a Generac system powered by a solar panel represents a more likely setup.

In another aspect of the present invention, the power supply recharges the one or more rechargeable batteries using the solar arrays.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates example embodiments of an article of manufacture providing a device for removing CO₂ gas from the atmosphere according to the present invention.

FIG. 2 illustrates a block diagram of an article of manufacture showing example embodiments of an article of manufacture providing a Swift CO₂ capture and disposal system for removing CO₂ gas from the atmosphere according to the present invention.

FIG. 3 illustrates an example embodiment with an outside enclosure of the article of manufacture providing a Swift CO₂ capture and disposal system for removing CO₂ gas from the atmosphere according to the present invention.

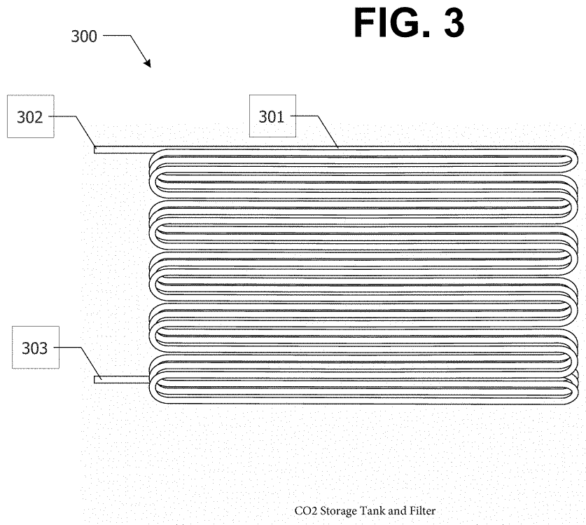

### DETAILED DESCRIPTION

This application relates in general to an article of manufacture for providing an environmental treatment device, and more specifically, to an article of manufacture providing a Swift CO₂ capture and disposal system for removing CO₂ gas from the atmosphere according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture providing a device for removing CO₂ gas from the atmosphere according to the present invention. The term user herein refers to one or more users.

The term “invention” or “present invention” refers to the invention being applied for via the patent application with the title “Swift CO₂ Capture and Disposal System.” “Invention” may be used interchangeably with “CO₂ device.”

Some embodiments of the present invention may comprise an independent power supply so as to enable operation without connection to an electrical power grid. Some embodiments may comprise a CO₂ storage tank containing a CO₂ filter, wherein the CO₂ filter comprises polyethyleneimine (PEI) laced with silica.

PEI material with silica fibers is arranged inside the CO₂ tank as a winding filter element with a hollow core, such that airflow travels through the center core of the filter. Incoming ambient air travels through the core center to help ensure maximum CO₂ capture and exits as CO₂ disposal output. As indicated by the CO₂ Storage Parameters Chart below: with an ambient air blower delivering 1424 cfm (cubic feet/minute), a storage tank captures 728 pounds of CO2 in a 7 day period, and 2912 pounds in 4 weeks. A system with 3 storage tanks will deliver 3 times those amounts. Once the CO₂ storage tank is saturated, the output CO2 detector will indicate zero; the tank is now saturated. Once saturated, we are now ready to dump captured CO₂ into the disposal well. A hot water line 219 is attached to a filter input and pumps hot water at a temperature above 185 degrees Fahrenheit. At 185 degrees, the PEI loses the capacity to hold CO₂ that is now a floating substance being flushed out and delivered to the CO₂ disposal well and the storage tank A single CO2 storage tank stores 2,912 pounds of CO₂ monthly; the 3-tank system stores 8,736 pounds monthly.

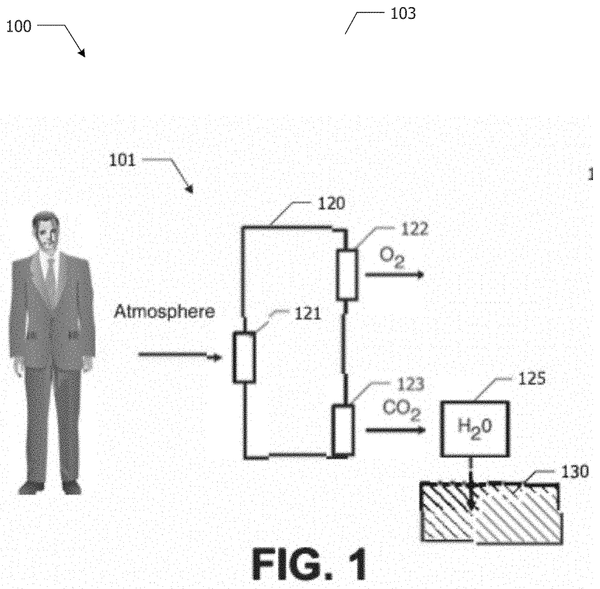

In general, the present disclosure relates to an article of manufacture providing a Swift CO₂ capture and disposal system for removing CO₂ from the atmosphere according to the present invention. To better understand the present invention, FIG. 1 illustrates example embodiments of an article of manufacture providing a device for removing CO₂ from the atmosphere according to the present invention. The Swift CO2 capture and disposal system 101 is intended to be installed in isolated and rural areas, typically away from the electrical grid, operating 24/7 to capture CO₂ and store the CO₂.

The CO₂ detector 215, and the sour gas filters at the input and output points of the capture chamber detect the CO₂ levels to ensure that CO₂ levels at output are always lower than levels at input to indicate that the gas is being filtered and stored. The filter is saturated and cannot capture additional CO₂ once the input and output CO₂ levels become equal. A controller stops the air blower fan and the device transitions to the CO₂ dumping phase.

Depending on where the device is installed geographically, different chemical components will be found in the CO₂ (SO₂, H₂S, SO₃, NO, NO₂, CO, O₃, PM, Lead). An excess of these sour gases appears dependent on the location. A filter for a particular sour gas can be installed at a point before ambient air enters the CO₂ storage tank and the sour gas output reading will indicate the effectiveness of the filter.

Science informs how much ambient air to blow into the tank to capture the level of CO₂ desired in a given time frame; see chart below for single tank operation. The system/device will be a 3-tank operation to do 3× as much work. The tank must be of a suitable size to hold the PEI material and the desired carbon capture weight.

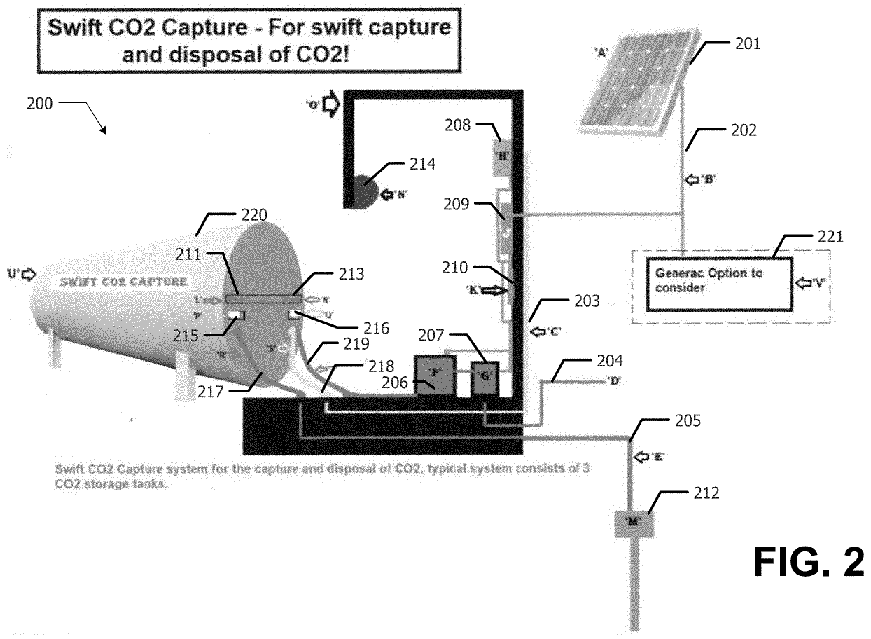

A Swift CO₂ capture and disposal system 101 is a device designed to suck in air containing carbon dioxide (CO₂) and direct the captured CO₂ to the earth in disposal wells. The Swift CO₂ capture and disposal system 101 operates by drawing atmospheric air into the device 101 through an input port 121. The atmospheric air includes both O₂ and CO₂ as well as other gasses. The Swift CO₂ capture and disposal system 101 extracts the CO₂ from the atmospheric air and passes the CO₂ through a captured CO₂ output port 123 to be mixed with water 125. The O₂ and other constituent gasses are expelled out a separate exhaust port 122. The water, having dissolved the CO₂ gas contained therein, may be stored into rock formations 130 for long term storage. The hot water causes the filter to lose its ability to trap CO₂ that is now free flowing, the hot water is the vehicle by which the CO₂ travels from the system to the dumping well. Additional details regarding the Swift CO₂ capture and disposal system 101 are described below in reference to FIG. 2.

FIG. 2 illustrates another example embodiment of an article of manufacture providing a Swift CO₂ capture and disposal system for removing CO₂ gas from the atmosphere according to the present invention. The example embodiment of a Swift CO₂ capture and disposal system 200 shown in FIG. 2 is constructed using a stand-alone photocell panel apparatus 201, an electrical power line 202, an ambient air line blower 203, an input water line 204, a CO₂ disposal line 205, a water heater 206, a water softener 207, an ambient air blower for the CO₂ tank 208, rechargeable batteries 209, a circuit breaker panel 210, an output sour gas detector 211, a CO₂ disposal well 212, an input sour gas detector 213, an enclosure 214, an output CO₂ detector 215, an input CO₂ detector 216, a CO₂ disposal line 217, an input ambient air line 218, a hot water input line 219, and a CO2 storage tank 220.

The present invention is an article of manufacture for providing a Swift CO₂ capture and disposal system for removing CO₂ gas from the atmosphere. The Swift CO₂ capture and disposal system 200 includes a capture chamber having a specialized filter that behaves like a fly-trap for CO₂ to capture CO₂ from incoming ambient air being blown into a capture chamber input port and exiting via an exhaust port from the capture chamber back to the atmosphere. Upon the specialized filter reaching saturation, the CO₂ disposal phase begins, whereby (1) A hot water source created by a hot water heater 206, is connected to the input port and (2) A drain line connected to the output port is routed to the CO₂ disposal unit. When exposed to temperatures at 185 degrees Fahrenheit or higher, the specialized filter loses its ability to hold the CO₂ that is now free flowing and being routed to the CO₂ disposal unit. The CO₂ disposal unit is a well containing materials that prevent the dumped CO₂ from returning to the surface and back to the atmosphere.

PEI material with silica fibers is arranged inside the CO₂ tank 220 as a winding filter element with a hollow core, such that incoming ambient air travels through the core center to help ensure maximum CO₂ capture and exits as CO₂ disposal output. As indicated by the CO₂ Storage Parameters Chart below, with an ambient air blower 208 delivering 1424 cfm, the storage tank 220 captures 728 pounds of CO₂ in a 7-day period and 2912 pounds in 4 weeks. A system 200 with 3 storage tanks will deliver 3 times that amount, or 8,736 pounds monthly. Once the CO₂ storage tank 220 is saturated, the output CO₂ detector 215 will indicate zero; the tank 220 is now saturated. Once saturated, the Swift CO₂ capture and disposal system 200 is now ready to dump captured CO₂. A hot water line 206 is attached to the filter input and pumps hot water at a temperature above 185 degrees Fahrenheit so the PEI core loses the capacity to hold CO₂ that is now a floating substance being flushed out and delivered to the CO₂ disposal well.

TABLE 1
CO₂ Storage Parameters

| | Ambient | CO₂ Stored | | CO₂ Stored | CO₂ Stored | | PEI lbs. |
|---|---|---|---|---|---|---|---|
| Fact | Air CMF | in 24 hours | | Weekly | Monthly | | in Tank |
| 1 | 356 | 26 | lbs. | 182 lbs. | 728 | lbs. | 10,366 |
| 2 | 712 | 52 | lbs. | 364 lbs. | 1,456 | lbs. | 20,732 |
| 3 | 1068 | 88 | lbs. | 546 lbs. | 2,184 | lbs. | 31,098 |
| 4 | 1424 | 108 | lbs. | 728 lbs. | 2,912 | lbs. | 41,464 |

During operation, the Swift CO₂ capture and disposal system 101 alternates between an CO₂ capture phase and a CO₂ dumping phase. During “CO2 capture phase,” the ambient air line 203 is attached to the input port of the CO₂ storage tank 220. Ambient air contains CO₂, O₂, and all sour gases. As ambient air passes through the CO₂ storage tank 220, from input port and exiting via the output port, the CO₂ is trapped/captured by the filter element that is made of the material that behaves like ‘FLY-TRAP’ for CO₂. All remaining components of the air exits the system via the output port. This phase continues until the storage tank becomes saturated.

During “CO₂ Dumping phase,” the ambient air line 203 is removed from CO₂ storage tank 220 input port and the hot water line 204 is attached to the input port of the storage tank 220. Also, the CO₂ disposal line 217 is attached to the output port of the storage tank 220. At this point, hot water is being pumped through the system from input port, exiting via output port through the CO₂ Dumping line 217 directed to the CO₂ Dumping well The HOT water at a temperature above 185 degrees Fahrenheit causes CO₂ trapped/captured by filter to be released, that captured CO₂ flows with the water to the dumping CO₂ disposal well 212.

The stand-alone photocell panel apparatus 201 generates electrical power from sunlight to permit system 200 to operate. The stand-alone photocell panel apparatus 201 is coupled to the rechargeable batteries 209 by the electrical power line 202 to store the electrical energy for later use. Generation of the electrical energy for use by the Swift CO₂ capture and disposal system 101 may utilize alternate forms of obtaining electrical power from solar cells. Each of these alternatives may be used in place of the stand-alone photocell panel apparatus 201.

The ambient air line blower line 203 directs the ambient air from the ambient air blower 208 into the storage tank 220.

The input water line 204 receives input water from an external water source for use by the hot water heater 206 and the water softener 207 when needed.

The CO₂ disposal line 205 provides a path for the CO₂ to flow to the CO₂ disposal well 212 for storage from the storage tank 220. The CO₂ disposal well 212 is the ultimate repository for the CO₂ captured from the ambient air.

The water heater 206 generates the hot water used to remove the captured CO₂ from the PEI capture material. The water heater 206 connects to the storage tank 220 by the hot water line 219. The water softener 207 may be utilized as needed to remove unwanted minerals from the water before heating and used to release the CO₂ from the PEI capture material.

The ambient air blower 208 moves the outside ambient air from outside the Swift CO₂ capture and disposal system 101 into the CO₂ tank 208.

The circuit breaker panel 210 provides an electrical circuit breaker between the stand-alone photocell panel apparatus 201 and the electrical components within the Swift CO₂ capture and disposal system 101. The circuit breakers therein provide protection from electrical power spikes and the drawing of excessive electrical current that may damage these components.

The output sour gas detector 211 and the input sour gas detector 213 permits the Swift CO₂ capture and disposal system 101 determine the efficiency of its operation. Ambient air contains many sour gases and depending on the geographic area where the Swift CO₂ capture and disposal system 101 is installed, certain undesirable sour gases may be higher than desired. In such cases, the Swift CO₂ capture and disposal system 101 can utilize filters to filter out or greatly reduce that particular sour gas, if such filter exists. The sour gas filters at the input lets the Swift CO₂ capture and disposal system 101 know the sour gas levels entering the system. The sour gas filter at the output leaving the Swift CO₂ capture and disposal system 101.

The enclosure 214 surrounds the components of the Swift CO₂ capture and disposal system 101. The ambient air is directed into the enclosure 214 by the ambient air blower 203 and into the storage tank 220. The processed air is vented out of the Swift CO₂ capture and disposal system 101 once the CO₂ has been removed, and the CO₂ is stored underground as disclosed herein.

The output CO₂ detector 215 is connected to the storage tank 220 to determine when the PEI capture material has become saturated. The input CO₂ detector 216 determines the amount of CO₂ present in the incoming ambient air and the output CO₂ detector 215 determines the amount of CO₂ remaining in the processed air. These values provide a measure of the efficiency of the Swift CO₂ capture and disposal system 101.

The CO₂ disposal line 217 connects to the storage tank 220 and runs to mate with the CO₂ disposal line 205 on its way to the CO₂ disposal well 212.

The input ambient air line 218 connects the ambient air line blower line 203 and thus the ambient air blower 208 into the storage tank 220 enabling the removal of the CO₂.

In some embodiments, the system may require in excess of 77 square feet of solar panel. The square footage area may be done with multiple smaller sections, for example 150 square feet can be done with 3-50 square feet panels or 6-25 feet panels.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture providing a Swift CO₂ capture and disposal system for removing CO₂ gas from the atmosphere, the Swift CO₂ capture and disposal system comprises:
a capture chamber having a CO₂/O₂ processing unit;
an intake port into the capture chamber;
an exhaust port from the capture chamber; and
the CO₂/O₂ processing unit comprising:
a captured CO₂ transfer port;
a fan having a fan motor for moving air into and out of the capture chamber through the intake port and the exhaust port;
a filter element for binding with the CO₂ within the capture chamber;
a heater element for raising the temperature of the filter element to release the bound CO₂ from the filter element generating captured CO₂; and
a controller, the controller configured to cause the CO₂/O₂ processing unit to:
open the intake port and the exhaust port;
activate the fan motor to draw atmospheric air into the capture chamber;
after a period of time, close the intake port and the exhaust port and deactivate the fan motor;
activate the heater to raise the filter temperature; and
open the captured CO₂ transfer port causing the captured CO₂ to pass out of the capture chamber.

2. The Swift CO₂ capture and disposal system according to claim 1, wherein the filter element utilizes polyethyleneimine (PEI) laced with silica to bind the CO₂ to the filter element.

3. The Swift CO₂ capture and disposal system according to claim 1, wherein the Swift CO2 capture and disposal system further comprises:
a solar power dome having one or more solar power arrays;
a power supply for suppling electrical power to the Swift CO2 capture and disposal system; and
one or more rechargeable batteries.

4. The Swift CO₂ capture and disposal system according to claim 3, wherein the power supply recharges the one or more rechargeable batteries using the solar arrays.

5. The Swift CO₂ capture and disposal system according to claim 3, wherein the power supply recharges the one or more rechargeable batteries using an external AC power source.

6. The Swift CO₂ capture and disposal system according to claim 5, wherein the power supply uses the rechargeable batteries to provide electrical power to the Swift CO2 capture and disposal system when the external AC power source is unavailable.
